(19) United States
(12) Patent Application Publication
(10) Pub. No.: US 2022/0317782 A1
(43) Pub. Date: Oct. 6, 2022

(54) INTERACTIVE ENVIRONMENT WITH PORTABLE DEVICES

(71) Applicant: Universal City Studios LLC, Universal City, CA (US)

(72) Inventors: Wei Cheng Yeh, Orlando, FL (US); Rachel Elise Rodgers, Orlando, FL (US)

(21) Appl. No.: 17/708,910

(22) Filed: Mar. 30, 2022

Related U.S. Application Data
(60) Provisional application No. 63/169,471, filed on Apr. 1, 2021.

(51) Int. Cl. G06F 3/0346; G06F 3/038; G06F 3/0482; G06F 3/16; H04B 1/69; A63G 31/00; A63F 13/79; A63F 13/533; A63F 13/837; A63F 13/54

(52) U.S. Cl. CPC G06F 3/0346; G06F 3/038; G06F 3/0482; G06F 3/16; H04B 1/69; A63G 31/00; A63F 13/79; A63F 13/533; A63F 13/837; A63F 13/54; G06F 2203/0384; A63F 2300/308; A63F 2300/5546; A63F 2300/6081; A63F 2300/8076

(57) ABSTRACT

An interactive system includes a portable device configured to be carried by a user as the user travels through an interactive attraction. The portable device includes a trigger device and first ultra-wideband (UWB) circuitry. A central system includes second UWB circuitry and one or more processors. The one or more processors are configured to determine a location and an orientation of the portable device within the interactive attraction based on communication between the first UWB circuitry and the second UWB circuitry, receive an indication of actuation of the trigger device via communication between the first UWB circuitry and the second UWB circuitry, and display a virtual projectile on a display screen of the interactive attraction based on the location and the orientation of the portable device during the actuation of the trigger device.

### CROSS-REFERENCE TO RELATED APPLICATION

This application claims priority to and the benefit of U.S. Provisional Application No. 63/169,471, entitled “INTERACTIVE ENVIRONMENT WITH PORTABLE DEVICES” and filed Apr. 1, 2021, which is incorporated by reference herein in its entirety for all purposes.

### BACKGROUND

This section is intended to introduce the reader to various aspects of art that may be related to various aspects of the present disclosure. This discussion is believed to be helpful in providing the reader with background information to facilitate a better understanding of the various aspects of the present disclosure. Accordingly, it should be noted that these statements are to be read in this light and not as admissions of prior art.

Amusement parks may include various entertainment attractions. Some entertainment attractions may provide an interactive environment for guests. For example, the guests may view an animated character on a display screen within the interactive environment, and the guest may provide inputs to control movement of the animated character on the display screen within the interactive environment.

### BRIEF DESCRIPTION

Certain embodiments commensurate in scope with the originally claimed subject matter are summarized below. These embodiments are not intended to limit the scope of the disclosure, but rather these embodiments are intended only to provide a brief summary of certain disclosed embodiments. Indeed, the present disclosure may encompass a variety of forms that may be similar to or different from the embodiments set forth below.

In an embodiment, interactive system includes a portable device a portable device configured to be carried by a user as the user travels through an interactive attraction. The portable device includes a trigger device and first ultra-wideband (UWB) circuitry. A control system includes second UWB circuitry and one or more processors. The one or more processors are configured to determine a location and an orientation of the portable device within the interactive attraction based on communication between the first UWB circuitry and the second UWB circuitry, receive an indication of actuation of the trigger switch via communication between the first UWB circuitry and the second UWB circuitry, and display a virtual projectile on a display screen of the interactive attraction based on the location and the orientation of the portable device during the actuation of the trigger device.

In an embodiment, a method of operating an interactive system includes determining, using one or more processors, a location and an orientation of a portable device within an interactive attraction based on communication between first UWB circuitry of the portable device and second UWB circuitry positioned about the interactive attraction. The method also includes receiving, at the one or more processors, an indication of actuation of the trigger device via communication between the first UWB circuitry and the second UWB circuitry. The method further includes displaying, via the one or more processors, a virtual projectile on a display screen of the interactive attraction based on the location and the orientation of the portable device during the actuation of the trigger device.

In an embodiment, an interactive system includes a portable device having a memory device configured to store a user profile for a user of the portable device. The portable device also includes a processor configured to determine an attribute of a virtual projectile for the portable device based on the user profile. The portable device further includes communication circuitry configured to communicate the attribute of the virtual projectile to a control system to cause the control system to display the virtual projectile with the attribute on a display screen that is separate from the portable device.

### BRIEF DESCRIPTION OF THE DRAWINGS

These and other features, aspects, and advantages of the present disclosure will become better understood when the following detailed description is read with reference to the accompanying drawings in which like characters represent like parts throughout the drawings, wherein:

FIG. 1 is a schematic illustration of an interactive system, in accordance with present embodiments;

FIG. 2 is a schematic illustration of a portable device that may be utilized as part of the interactive system of FIG. 1, in accordance with present embodiments;

FIG. 3 is a side view of a portable device that may be utilized as part of the interactive system of FIG. 1, wherein the portable device includes an array of ultra-wideband (UWB) tags, in accordance with present techniques;

FIG. 4 is a flow diagram of a method of operating the interactive system of FIG. 1, wherein certain processing steps are carried out by the portable device, in accordance with present techniques;

FIG. 5 is a flow diagram of a method of operating the interactive system of FIG. 1, wherein certain processing steps are carried out by a control system, in accordance with present techniques; and

FIG. 6 is a schematic illustration of an interactive system that utilizes data-over-sound (DOS) techniques, in accordance with present techniques.

### DETAILED DESCRIPTION

One or more specific embodiments will be described below. In an effort to provide a concise description of these embodiments, not all features of an actual implementation are described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present disclosure, the articles “a,” “an,” “the,” and “said” are intended to mean that there are one or more of the elements. The terms “comprising,” “including,” and “having” are intended to be inclusive and mean that there may be additional elements other than the listed elements. One or more specific embodiments of the present embodiments described herein will be described below. In an effort to provide a concise description of these embodiments, all features of an actual implementation may not be described in the specification. It should be noted that in the development of any such actual implementation, as in any engineering or design project, numerous implementation-specific decisions must be made to achieve the developers' specific goals, such as compliance with system-related and business-related constraints, which may vary from one implementation to another. Moreover, it should be noted that such a development effort might be complex and time consuming, but would nevertheless be a routine undertaking of design, fabrication, and manufacture for those of ordinary skill having the benefit of this disclosure.

The present disclosure relates generally to an interactive environment that utilizes portable devices to provide interactive experiences to guests (e.g., users). In an embodiment, the interactive environment is implemented within an amusement park attraction, such as in a ride attraction in which the guests are carried in ride vehicles through the interactive environment and/or a walk-through attraction in which the guests walk through the interactive environment. In an embodiment, the amusement park attraction may be a hybrid attraction in which the guests are both carried (e.g., on a moving walkway) and are permitted to walk (e.g., along the moving walkway) through the interactive environment. The interactive environment may be distributed across multiple different amusement park attractions (e.g., geographically separated from one another), such as across multiple different ride attractions, walk-through attractions, and/or hybrid attractions. Additionally or alternatively, the interactive environment may be included within one or more themed areas and/or distributed across multiple different themed areas having a common theme or different themes. Additionally or alternatively, the interactive environment may include a live show (e.g., with performers), and the guests in an audience may participate in the live show using their portable devices.

The portable devices may be any of a variety of types of devices that are configured to be carried, held, and/or worn by the guests. For example, the portable devices may include targeting devices (e.g., blasters), wands, toys, figurines, clothing, jewelry, bracelets, headgear, medallions, glasses, and/or any combination thereof (e.g., targeting devices integrated into bracelets). In an embodiment, the portable devices may be configured to be used by multiple different guests over time. For example, a guest may pick up a portable device at an entrance to the interactive environment, use the portable device to participate in the interactive environment as the guest travels through the interactive environment, and then return the portable device as the guest exits the interactive environment. The portable device may be made available again at the entrance to the interactive environment (e.g., after cleaning), and then another guest may pick up the portable device at the entrance to the interactive environment and use the portable device to participate in the interactive environment, and so on.

As discussed herein, the portable devices may enable the guests to interact with (e.g., to control) features within the interactive environment. For example, a portable device may be a targeting device, and the guest may actuate a trigger device (e.g., trigger switch; trigger input) of the portable device to initiate a simulation of a delivery of a virtual projectile toward an interactive element (e.g., an animated object) that is displayed on a display screen within the interactive environment. In response, the display screen may display an image (e.g., moving image; video) that portrays the virtual projectile landing on (e.g., striking; hitting) the interactive element. Advantageously, the portable devices are equipped with various components that obtain data, process the data on-board the portable devices, and/or efficiently communicate the data, which may improve computer system operations by reducing latency and/or providing a more immersive experience to the guests.

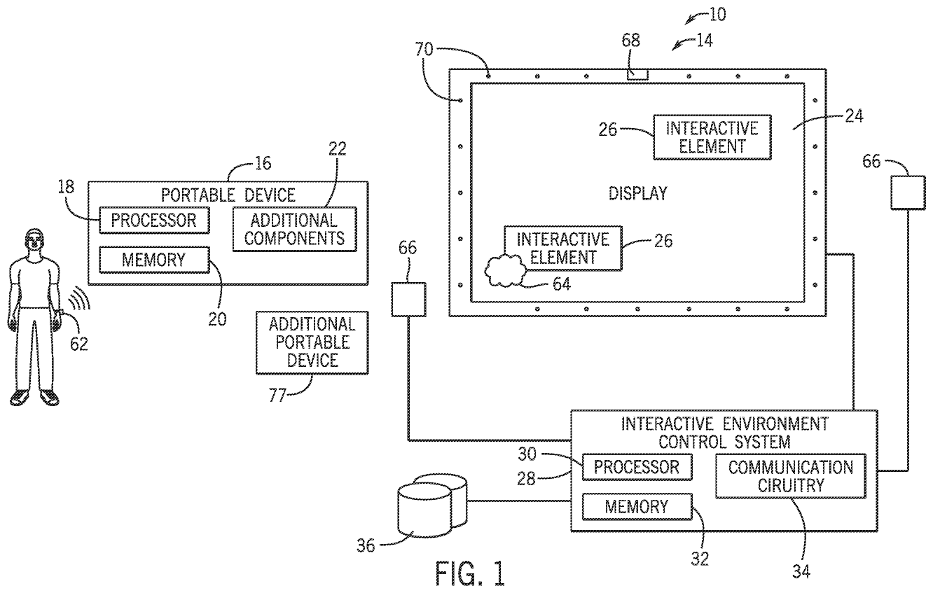

FIG. 1 illustrates an interactive system 10 that facilitates interactions within an interactive environment 14, in accordance with an embodiment of the present disclosure. The interactive environment 14 may be within an amusement park attraction or other suitable location. As shown, a guest (e.g., user) may carry a portable device 16 (e.g., interactive object) that includes a processor 18, a memory device 20, and additional components 22 through the interactive environment 14. The interactive environment 14 may include one or more display screens 24 that are configured to display interactive elements 26. The interactive elements 26 may include images (e.g., moving images; videos) of animated objects, such as symbols, coins/prizes, vehicles, and/or characters.

An interactive environment control system 28 (also referred to herein as “a control system” to facilitate discussion) may include a processor 30, a memory device 32, and communication circuitry 34 to enable the control system 28 to control features within the interactive environment 14 (e.g., instruct display of the interactive elements 26 on the display screen 24 and/or to provide other audio/visual effects) and/or communicate with the portable device 16. Additionally, one or more databases 36 that store guest profiles for the guests may be accessible to the portable device 16, the control system 28, and/or other devices and systems.

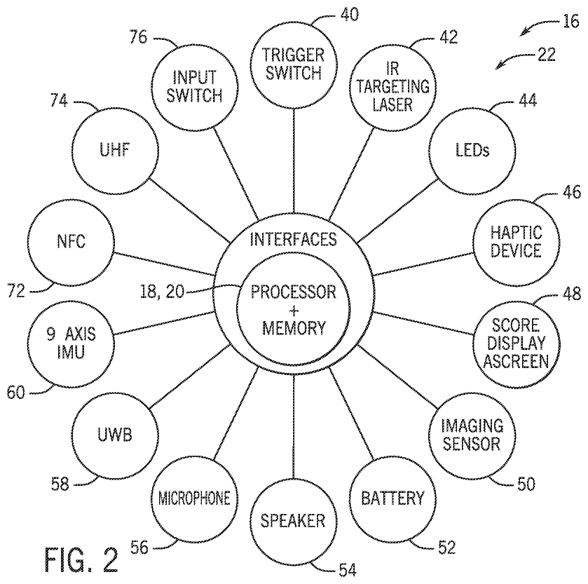

FIG. 2 illustrates examples of the additional components 22 that may be included in the portable device 16 to facilitate output of guest-specific special effects within the interactive environment 14 of FIG. 1, in accordance with an embodiment of the present disclosure. As shown, the portable device 16 may include the processor 18 and the memory device 20. The processor 18 interfaces with the additional components 22, which may include a trigger device 40, a targeting laser 42, a light emitter 44 (e.g., light emitting diode [LED]), a haptic device 46, a display screen 48, an imaging sensor 50 (e.g., camera), a battery 52 (and battery management system), a speaker 54, a microphone 56, an ultra-wideband (UWB) circuitry 58, an inertial measurement unit 60, a near-field communication (NFC) circuitry 72, an ultra-high frequency (UHF) circuitry 74, and/or an input switch 76 (e.g., push-button). The targeting laser 42, the UWB circuitry 58, the NFC circuitry 72, and/or the UHF circuitry 74 may be considered to be communication circuitry. Furthermore, it should be appreciated that the portable device 16 may include any number of each of the additional components 22 (e.g., multiple light emitters 44) and/or any combination of the additional components 22. Furthermore, some of the additional components 22 may be omitted and/or other components may be added.

With reference to FIGS. 1 and 2, in operation, the guest may enter the interactive environment 14 by passing through an entrance of the interactive environment 14. In an embodiment, the guest may obtain (e.g., pick up; select) the portable device 16 as the guest enters the interactive environment 14. Thus, the portable device 16 may not be pre-registered or otherwise linked to the guest (e.g., the guest profile of the guest) prior to the guest entering the interactive environment 14. Instead, the portable device 16 is temporarily registered and linked to the guest as the guest enters the interactive environment 14 and/or while the guest carries the portable device 16 to participate in the interactive environment 14.

The portable device 16 may be temporarily registered and linked to the guest through any of a variety of linking techniques. In an embodiment, the portable device is linked to the guest through communication with a personal device 62 that is carried by the guest and that is configured to output a unique identifier associated with the guest. The personal device 62 may be a mobile phone, a bracelet, or any other suitable device. The personal device 62 may be a device that the guest also uses outside of the interactive environment 14 for personal tasks that are unrelated to the interactive environment 14 (e.g., the mobile phone that the guest uses to complete personal phone calls), or the personal device 62 may be a device that the guest purchases (or receives in exchange for an admission fee) specifically for use in the interactive environment 14 and/or in the amusement park that has the interactive environment 14.

In an embodiment, the portable device 16 may be configured to periodically scan for and/or request the unique identifier from the personal device 62. For example, the portable device 16 may use the NFC circuitry 72 to scan for the unique identifier from the personal device 62; however, the portable device 16 may use any suitable radiofrequency identification (RFID) techniques to scan for a RFID tag (that stores or is indicative of the unique identifier) in the personal device 62. As another example, the portable device 16 may use data-over-sound (DOS) techniques to request sound signals that indicate the unique identifier from the personal device 62. Other types of communication are envisioned, such as Bluetooth, WiFi, or the like.

The processor 18 may be triggered to initiate the scan and/or request upon occurrence of an event. The event may include the IMU 60 detecting certain movements (e.g., lifting the portable device 16 in a manner that is consistent with initial pick up), the UWB circuitry 58 indicating that the portable device 16 is at the entrance of the interactive environment 14, receipt of a link command input from the guest or an operator (e.g., via pressing the input switch 76 on the portable device 16 or a virtual button on the display screen 48 of the portable device 16), and/or powering on the portable device 16.

In an embodiment, once the portable device 16 receives the unique identifier from the personal device 62, the portable device 16 may then transmit the unique identifier along with its own device identifier to the control system 28. This enables the control system 28 to associate the portable device 16 with the guest profile to thereby link the portable device 16 to the guest (e.g., temporarily, such as while the guest travels through the interactive environment 14). Additionally or alternatively, the guest profile (e.g., some or all settings associated with the guest profile) may be communicated to and/or stored on the portable device 16 (e.g., temporarily, such as while the guest travels through the interactive environment 14). For example, if the guest profile establishes a preference for the virtual projectile, the preference may be communicated to and/or stored on the portable device 16. As another example, if the guest profile establishes a color scheme for the guest, the color scheme may be communicated to and/or stored on the portable device 16. It should be appreciated that the portable device 16, the control system 28, the one or more databases 36, and/or the personal device 62 may communicate via any suitable communication pathways to carry out various techniques disclosed herein, such as to exchange identifier(s), link the portable device 16 to the guest, and/or to provide the guest profile to the portable device 16. For example, the personal device 62 may retrieve the guest profile from the one or more databases 36 and communicate the guest profile to the portable device 16. As another example, the personal device 62 may receive the device identifier from the portable device 16, and then provide the unique identifier and the device identifier to the control system 28.

In an embodiment, the interactive system 10 may be configured to carry out an iterative process to link the portable device 16 to the guest. In particular, prior to or upon entering the interactive environment 14, the guest may open and interact with an application (e.g., software application) on the personal device 62. Through the interaction with the application on the personal device 62, the guest may create and/or modify features of the guest profile of the guest. For example, the guest may create the guest profile with a preference for a type of virtual projectile (e.g., water, goo, ball), a mode (e.g., ice, fire, water), a color scheme (e.g., purple, green, blue), or the like. Furthermore, through the interaction with the application on the personal device 62, the guest may create and/or modify features of an additional guest profile for an additional guest (e.g., a child of the guest, a companion of the guest) or for the guest (e.g., if the guest would like to have the ability to select from multiple, different guest profiles). Indeed, the guest may create and/or modify features of any number of guest profile(s) (e.g., 1, 2, 3, 4, 5, or more), and the guest profile(s) may be stored in the one or more databases 36.

Once the guest profile(s) are established, the guest may bring the personal device 62 into proximity of the portable device 16 (e.g., within NFC range, such as within 3, 4, or 5 centimeters) to establish communication between the personal device 62 and the portable device 16. Then, the personal device 62 may provide the unique identifier to the portable device 16, which then relays the unique identifier to the control system 28 to enable identification of the guest profile in the one or more databases 36. The control system 28 associates the portable device 16 with the guest profile and also provides an output that causes the portable device 16 to provide a linking output to notify the guest that the portable device 16 has been linked to the guest. For example, the guest profile may include or be at least temporarily associated with a color scheme (e.g., blue), and the light emitter(s) 44 on the portable device 16 may illuminate in a color (e.g., blue) that corresponds to the color scheme. It should be appreciated that the control system 28 may provide the output that includes the guest profile and/or instructions to control the additional components 22 in a particular way (e.g., to turn on the light emitter(s) 44 with the color) to cause the portable device 16 to provide the linking output.

Upon the guest bringing the personal device 62 into proximity of an additional portable device 77 (e.g., within NFC range, such as within 3, 4, or 5 centimeters) to establish communication between the personal device 62 and the additional portable device 77, the personal device 62 may provide the unique identifier to the additional portable device 77. Then, the additional portable device 77 relays the unique identifier to the control system 28 to enable identification of the additional guest profile in the one or more databases 36. Then, the control system 28 associates the additional portable device 77 with the additional guest profile, and also provides an additional output that causes the additional portable device 77 to provide a respective linking output to notify the additional guest that the additional portable device 77 has been linked to the additional guest. For example, the additional guest profile may include or be at least temporarily associated with a different color scheme (e.g., purple), and the light emitter(s) 44 on the portable device 16 may illuminate in a color (e.g., purple) that corresponds to the color scheme. The control system 28 may provide the output that includes the additional guest profile and/or instructions to control the additional components 22 in a particular way (e.g., to turn on the light emitter(s) 44 with the different color) to cause the portable device 16 to provide the linking output. The color schemes for the guest profiles may be known to the users and/or may be reflected by the personal device 62, such as via a color indicator presented via the personal device 62 that matches a color of the linking output.

In this way, the interactive system 10 may enable a single personal device 62 to efficiently link multiple different guest profiles to respective portable devices (e.g., the guest profile to the portable device 16, the additional guest profile to the additional portable device 77, and so on) to support high throughput of guests as they collect the portable devices 16, 77. The linking process may be an automatic iterative process because the control system 28 recognizes the unique identifier from the personal device 62, accesses the guest profile associated with the personal device 62, and provides the output to cause the portable device 16 to provide the linking output that is appropriate for the first user profile. Then, in response to the same personal device 62 being brought into proximity of the additional portable device 77, the control system 28 recognizes the unique identifier from the personal device 62, recognizes that the guest profile has already been linked to the portable device 16 (and thus, disregards or skips over the guest profile), accesses the additional guest profile associated with the personal device 62, instructs the additional portable device 77 to provide the linking output that is appropriate for the additional user profile, and so on.

The linking output may also assist multiple guests to differentiate their portable devices 16, 77, even if each guest has their own personal device 62. For example, a first guest in a line may hold their personal device 62 against the portable device 16, which may then illuminate in a first color that operates to visually confirm to the first guest that the portable device 16 has been linked to their guest profile. At the same time (or close in time), a second guest in the line may hold their user device against the additional portable device 77, which may then illuminate in a second color (e.g., different than the first color) that operates to visually confirm to the second guest that the additional portable device 77 has been linked to their guest profile. Similarly, the guest that has set up multiple guest profiles may select a particular guest profile for one pass through the interactive environment 14 and hold the personal device 62 against the portable device 16, which may then illuminate in a first color that operates to visually confirm to the guest that the portable device 16 has been linked to the particular guest profile.

The portable device 16, the control system 28, the one or more databases 36, and/or the personal device 62 may communicate via any suitable communication pathways to carry out the various techniques disclosed herein. Thus, the personal device 62 may provide the output that causes the portable device 16 to provide the linking output and/or may communicate the association of the portable device 16 and the guest profile to the control system 28. Similarly, the personal device 62 may provide the additional output that causes the additional portable device 77 to provide the linking output and/or may communicate the association of the additional portable device 77 and the additional guest profile to the control system 28. To facilitate discussion, the personal device 62 and the control system 28 may both be referred to herein as “external devices or systems” to indicate that certain processing steps may be carried out by these external devices or systems that are separate (e.g., physically separate) from the portable device 16.

In an embodiment, the portable device 16 may temporarily store the unique identifier and/or the portable device 16 may use the unique identifier to access and/or to download the guest profile for the guest. For example, the portable device 16 may access and/or download the guest profile for the guest by using the UWB circuitry 58 to communicate with the control system 28, which accesses the guest profile from the one or more databases 36 and provides the guest profile to the portable device 16. However, it is envisioned that the portable device 16 may receive the guest profile from the personal device 62 or through another communication pathway. For example, the personal device 62 may store the guest profile (e.g., locally on a storage device) and/or access the guest profile from the one or more databases 36, and the personal device 62 may provide the guest profile to the portable device 16.

The guest profile for the guest may be a stored log of achievements and/or data that is unique (or at least tailored) to the guest. The guest profile may depend on previous visits to and/or experiences in the interactive environment 14. The guest profile may include data, such as a number of visits, a number of points accumulated during one or more visits, an average number of points accumulated per visit, a total number of points accumulated across all visits, which interactive elements 26 the guest was able to successfully target (e.g., strike) during one or more visits, a number of times the guest contacted the trigger device 40 during one or more visits, a percent accuracy (e.g., strikes/attempts) during one or more visits, a time to travel through the interactive environment 14 during one or more visits, a current level achieved in the interactive environment 14, a highest level achieved in the interactive environment 14, a type of the personal device 62 carried by the guest, a history of purchases made by the guest, a history of other interactive environments 14 visited by the guest, a history of amusement park attractions visited by the guest, a history of projectiles used during one or more visits, and/or any of a variety of other information related to a performance and/or an experience related to the interactive environment 14. The guest profile may also include characteristics of the guest, such as an age of guest. The guest profile may also include preferences of the guest, such as preferred virtual projectiles (e.g., characteristics or attributes, such as colors, sizes, and/or types) and/or preferred interactive elements 26 (e.g., objects, characters). The guest profile may be referenced to provide the guest-specific special effects within the interactive environment 14, and the guest profile may be updated during each visit to the interactive environment 14. As noted herein, some or all elements of the guest profile may be transferred to and temporarily downloaded onto (e.g., stored on) the portable device 16.

As the guest travels through the interactive environment 14, the guest may be presented with the interactive elements 26 on the display screen 24. For example, animated objects may move across the display screen 24. An object within the interactive environment 14 may be for the guest to use the portable device 16 to target the interactive elements 26, such as by actuating the trigger device 40 to launch virtual projectiles toward the interactive elements 26. In an embodiment, an image 64 of the virtual projectiles may be shown on the display screen 24 alongside the interactive elements 26 (e.g., striking the interactive elements 26) and/or the interactive elements 26 may respond to successful targeting (e.g., virtual interaction/strike by the virtual projectiles; by disappearing or moving on the display screen 24) to provide feedback to the guest. In an embodiment, the interactive system 10 may award points (e.g., achievements) to the guest for each successful strike at the interactive elements 26, and the points may be added to the guest profile for the guest. In an embodiment, the portable device 16 and/or the control system 28 may track the successful targeting and update the guest profile for the guest as the guest travels through the interactive environment 14 (e.g., in real-time).

To carry out these operations in a manner that provides an immersive experience for the guest, the portable device 16 may utilize its additional components 22 in various ways. In particular, the portable device 16 may utilize the UWB circuitry 58 and/or the imaging sensor 50 as part of a real-time locating system that performs location tracking (e.g., location and/or orientation tracking) within the interactive environment 14. The UWB circuitry 58 (e.g., tags) may communicate with UWB circuitry 66 (e.g., anchors) in the interactive environment 14. The UWB circuitry 58, 66 may send a packet of information indicative of a location (e.g., relative to the UWB circuitry 66; relative to a coordinate system of the interactive environment 14) and/or an orientation (e.g., relative to a gravity vector; relative to a coordinate system of the interactive environment 14) of the portable device 16 to the processor 18 (or the processor 30) to enable the processor 18 (or the processor 30) to determine the location and/or the orientation of the portable device 16 within the interactive environment 14.

The imaging sensor 50 may be configured to obtain images of the interactive environment 14 around the portable device 16, and the imaging sensor 50 may provide the images to the processor 18 (or the processor 30) to enable the processor 18 (or the processor 30) to determine the location and/or the orientation of the portable device 16 within the interactive environment 14. For example, in response to receipt of an image that includes one or more visual markers 68 in the interactive environment 14, the processor 18 (or the processor 30) may use image matching to detect the visual markers 68 and to determine the location and/or the orientation of the portable device 16 within the interactive environment 14.

Additionally or alternatively, other information may be used to determine the location and/or the orientation of the portable device 16 within the interactive environment 14. For example, the microphone 56 may detect a particular sound that is associated with a particular region of the interactive environment 14 (e.g., emitted by a speaker that is at a fixed or otherwise known position in the interactive environment 14), and the microphone 56 may provide the sound to the processor 18 (or the processor 30) to enable the processor 18 (or the processor 30) to determine the location of the portable device 16 within the interactive environment 14. The IMU 60 may provide an IMU signal indicative of the orientation of the portable device 16 to the processor 18 (or to the processor 30). In an embodiment, the processor 18 (or the processor 30) may process the IMU signal to enable the processor 18 (or the processor 30) to determine the orientation of the portable device 16 within the interactive environment 14. The processing of the data from the UWB circuitry 58, the imaging sensor 50, and/or other ones of the additional components 22 by the processor 18 (or the processor 30) may enable efficient fusion of sensor data to determine the location and/or the orientation of the portable device 16 within the interactive environment 14.

In particular, the data from the UWB circuitry 58, the imaging sensor 50, and/or the IMU 60 may enable the processor 18 (or the processor 30) to perform trajectory mapping for the virtual projectiles (e.g., determine a trajectory, such as a virtual flight path, for the virtual projectiles). The trajectory of the virtual projectiles may be used to represent a hit location and/or an angle of impact of the virtual projectiles in the interactive environment 14 (e.g., on the display screen 24) to provide a realistic experience to the guest. The control system 28 may receive and/or determine the trajectory and then instruct the display screen 24 to display the virtual projectiles with the trajectory (e.g., to strike the interactive element 26 at the hit location and/or from above or from below with the angle of impact).

In an embodiment, the interactive environment 14 may utilize the UWB circuitry 58, the imaging sensor 50, and/or the IMU 60 to monitor targeting of the interactive elements 26 and to track successful (and possibly unsuccessful) targeting of the interactive elements 26 displayed on the display screen 24. In an embodiment, the processor 18 (or the processor 30) may assess images obtained by the imaging sensor 50, information provided by the UWB circuitry 58, and/or information provided by the IMU 60 to determine whether the guest has positioned and oriented the portable device 16 in a way that appropriately targets the interactive elements 26. For example, the images obtained by the imaging sensor 50 may show one interactive element 26 in an upper right corner of the display screen 24. Then, if the UWB circuitry 58 indicates sufficient proximity to the display screen 24 and/or that the portable device 16 is oriented upward, the processor 18 (or the processor 30) may determine that the portable device 16 is properly aimed at the interactive element 26. Then, upon actuation of the trigger device 40, the processor 18 (or the processor 30) may identify successful targeting of the interactive element 26 and update the guest profile for the guest. Furthermore, upon successful targeting of the interactive element 26, the control system 28 may instruct display of the virtual projectiles in an appropriate manner.

Notably, it is possible for the tracking and/or updating of the guest profile for the guest to be carried out on-board the portable device 16. In such cases, the portable device 16 may communicate to the control system 28 for only limited reasons, such as to cause the control system 28 to display the virtual projectiles in an appropriate manner, for example. In an embodiment, the UWB circuitry 58 (without the image sensor 50 and/or without the IMU 60 and/or without the targeting laser 42) is used to monitor targeting of the interactive elements 26 and to track successful (and possibly unsuccessful) targeting of the interactive elements 26 that are displayed on the display screen 24. Thus, in an embodiment, the processor 18 (or the processor 30) may assess only information provided by communication between the UWB circuitry 58 and the UWB circuitry 66 to determine whether the guest has positioned and oriented the portable device 16 in a way that appropriately targets the interactive elements 26.

It should be appreciated that the processor 18 (or the processor 30) may assess images obtained by the imaging sensor 50, as well as information provided by the UWB circuitry 58 and the IMU 60, for other purposes. In an embodiment, the processor 18 may assess this data and/or instruct communication of this data (e.g., via the UWB circuitry 58) to the control system 28 to cause various effects in the interactive environment 14 prior to actuation of the trigger device 40 of the portable device 16 (e.g., initiate pre-trigger functions). For example, the various effects may include moving or otherwise changing the interactive element 26 (e.g., to provide a visual effect of the interactive element 26 ducking and/or moving to evade targeting) in response to the data indicating that the portable device 16 is aimed at the interactive element 26 and prior to the actuation of the trigger device 40 of the portable device 16. As another example, the various effects may include moving or otherwise changing the interactive element 26 in response to the data from multiple portable devices indicating that a group of guests are near one another (e.g., in a cluster) and prior to actuation of the trigger devices 40 of the portable devices. In some such cases, the various effects may include moving one or more interactive elements 26 toward the group of guests or moving the one or more interactive elements 26 in a coordinated manner to attempt to drive the group of guests to disperse, such as by individually addressing each of the guests based on the respective orientation and location of their portable devices prior to actuation of the trigger devices 40 of the portable devices. These operational features may provide a dynamic, unique experience during each session, and may also utilize low latency data communication capabilities provided by the UWB circuitry 58, 66.

Furthermore, upon launch of the virtual projectile by actuation of the trigger device 40, the processor 18 (or the processor 30) may determine whether the actuation results in successful targeting of the interactive element 26. In response to the successful targeting, the control system 28 may take various actions (e.g., updates the guest profile on a back end; display the virtual projectile on the display screen 24; audio/visual effects in the interactive environment 14). In response to the successful targeting, the portable device 16 may display new available types of the virtual projectiles (e.g., via a menu shown on the display screen 48; water, goo, balls), initiate a new mode of the portable device 16 (e.g., shown on the display screen 48; a freeze mode in which the portable device 16 appears “frozen” and is inoperable by the guest, such that the trigger device 40 cannot be actuated and/or actuation of the trigger device 40 does not launch any virtual projectiles), initiate a lighting effect (e.g., the light emitter(s) 44 illuminate in a particular color, such as green for a hit or red from a miss), initiate a sound effect (e.g., the speaker 54 emits a first sound for a hit and a second sound for a miss), and/or initiate a haptic effect (e.g., the haptic device 46 causes vibration of the portable device 16 for a hit). The portable device 16 and the control system 28 may communicate, such as via the UWB circuitry 58, 66, to convey indications of successful targeting so that appropriate interactive features are provided in a coordinated manner on the portable device 16 and in the interactive environment 14 (e.g., on the display screen 24).

In an embodiment, the portable device 16 may be configured to generate an aiming pulse with the targeting laser 42. The aiming pulse may include infrared (IR) light, and the aiming pulse may be used to communicate with corresponding detectors 70 at the display screen 24. For example, the detectors 70 may be provided in an array (e.g., rows and/or columns) to detect coordinates (e.g., x, y coordinates) of an area (e.g., point) of impingement of the aiming pulse across the display screen 24. Upon detection of the aiming pulse by the detectors 70, the detectors 70 may provide detection signals to indicate characteristics of the IR light and/or the area of impingement to the control system 28.

The control system 28 may be configured to identify that the aiming pulse is aligned with or overlaps the interactive element 26. In response, the control system 28 may provide various effects, such as moving the interactive element 26 (e.g., to provide a visual effect of the interactive element 26 ducking and/or moving to evade targeting; prior to actuation of the trigger device 40). Generally, these and other effects may be provided in response to determining that the portable device 16 is aimed at the interactive element 26 (e.g., based on any suitable signals, such as the signals from the UWB circuitry 58).

In an embodiment, the aiming pulses from the targeting laser 42 may be emitted only in response to actuation of the trigger device 40 and/or may be encoded to communicate occurrence of the actuation of the trigger device 40. This may enable the control system 28 to accurately detect the successful targeting (or unsuccessful targeting). In an embodiment, the aiming pulse may be encoded with the unique identifier for the guest (or other unique identifier, such as the device identifier for the portable device 16 that is temporarily linked to the guest). This many enable the control system 28 to assign the achievement (e.g., the successful targeting, the points) to the guest profile for the guest on the back end and/or communicate the achievement back to the portable device 16 for the guest.

It should be appreciated that the portable device 16 and the control system 28 may communicate various types of information (including any of the information, data, and/or signals disclosed herein) via the UWB circuitry 58, 66 and/or the aiming pulse. For example, the trajectory for the virtual projectiles may be communicated via the UWB circuitry 58, 66 and/or the aiming pulse. The characteristics or attributes of the virtual projectiles may vary for different guests and/or over time for each guest. In an embodiment, the characteristics or attributes (e.g., color, size, and/or type) of the virtual projectiles may be set (e.g., by the processor 18 or by the processor 30) based on the guest profile and/or achievements logged in the guest profile, such as one color for a first level and another color for a second level. Then, the characteristics or attributes of the virtual projectiles may be communicated via the UWB circuitry 58, 66 and/or the aiming pulse.

Additionally or alternatively, the characteristics or attributes of the virtual projectiles may be set based on inputs at the portable device 16, such as an input of shaking the portable device 16 or otherwise moving the portable device 16 in a particular manner (e.g., pattern of movement). The guest may actuate the input switch 76 to toggle through a menu of available characteristics or attributes of the virtual projectiles and to make a selection. Additionally or alternatively, the characteristics or attributes of the virtual projectiles may be set based on the personal device 62 of the guest, such as one type for a first type of personal device 62 (e.g., representing a first character or team) and another type for a second type of personal device 62 (e.g., representing a second character or team). The characteristics or attributes may include the color (e.g., red, blue, green, yellow), the size (e.g., big, medium, small), and/or the type (e.g., water, goo, balls). The characteristics or attributes may include other features, such as a rate of firing and/or a number of virtual projectiles launched in response to each actuation of the trigger device 40.

In an embodiment, the processor 18 may determine that the characteristics or attributes of the virtual projectile should change (e.g., in response to the inputs), and the processor 18 may instruct the UWB circuitry 58 and/or the targeting laser 42 to communicate the change to the control system 28. The UWB circuitry 58 and/or the targeting laser 42 may communicate the change to the control system 28 prior to actuation of the trigger device 40 (e.g., in response to the inputs that caused the change) and/or upon actuation of the trigger device 40. Then, the control system 28 may instruct the display screen 24 to display the virtual projectile with the characteristic or attributes (e.g., with the new color).

In an embodiment, the processor 30 may determine that the characteristics or attributes of the virtual projectile should change (e.g., in response to successful targeting, achievements, level, portion of the interactive environment 14), and the processor 30 may communicate the change to the portable device 16 via the UWB circuitry 58, 66. For example, the processor 30 may communicate the change to the portable device 16, which may then show the new virtual projectile that is being utilized (e.g., without an option for change or selection by the guest using the portable device 16). As another example, the portable device 16 may then show multiple virtual projectiles that are now available for selection by the guest (e.g., via inputs at the input switch 76) on the display screen 48 for visualization by the guest.

As shown, the portable device 16 also includes various indicator devices, such as the light emitter(s) 44, the haptic device 46, the display screen 48, and/or the speaker 54. These indicator devices may be configured to provide various types of feedback to the guest as the guest travels through the interactive environment 14. For example, one of the more of the indicator devices may provide respective feedback upon the successful targeting of the interactive element 26 on the display screen 24 and/or upon points being assigned to the guest profile. One or more of the indicator devices may provide respective feedback related to the guest profile for the guest, such as an overall level. For example, the light emitter(s) 44 may be one color while the guest has a first number of points, and the light emitter(s) 44 may be another color while the guest has a second number of points. The display screen 48 may provide feedback as well, such as a number indicating points or level. The indicator devices and/or the display screen 48 may also respond to the interactive environment 14, such as to provide visual, tactile, and/or audio outputs on the portable device 16 in response to changes in the interactive environment 14. In an embodiment, the display screen 48 freezes or appears cracked in response to one of the interactive elements 26 appearing to throw a virtual projectile at the guest, as communicated from the control system 28. In an embodiment, the light emitter(s) 44 are red while other lights in the interactive environment 14 are red.

It should be appreciated that the feedback via the portable device 16 and/or the special effects in the interactive environment 14 may change in a dynamic and/or personalized manner as the guest travels through the interactive environment 14. For example, if the guest missed a particular interactive element 26 during a previous visit to the interactive environment 14, the control system 28 may make the particular interactive element 26 larger, make a movement of the particular interactive element 26 across the display screen 24 slower, and/or adjust the trajectory (or expand an area on the display screen 24 that is considered to overlap with the particular interactive element) to assist the guest in successfully targeting the particular interactive element during a current visit. Similarly, if the guest hit a particular interactive element 26 during a previous visit to the interactive environment 14, the control system 28 may make the particular interactive element 26 smaller and/or make a movement of the particular interactive element 26 across the display screen 24 faster to make the experience more challenging for the guest during a current visit. The same or similar changes may be made during the current visit based on the performance of the guest, so as to adjust a difficulty of the experience as the guest travels through the interactive environment 14 so that the guest has some success and/or a desirable degree of difficulty during the experience.

As noted herein, the portable device 16 may be only temporarily registered and linked to the guest while the guest travels through the interactive environment 14. Thus, the portable device 16 may be delinked from the guest through any of a variety of delinking techniques. In an embodiment, the portable device 16 is delinked from the guest when the periodic scans by the portable device 16 do not result in the return of the unique identifier for the guest and/or result in the return of another unique identifier for another guest (or operator). It should be appreciated that the processor 18 may be triggered to delink from the guest upon occurrence of an event, such as by the IMU 60 detecting certain movements (e.g., returning the portable device 16 in a manner that is consistent with drop off), the UWB circuitry 58 indicating that the portable device 16 is at the exit of the interactive environment 14, upon a delink command input, and/or upon powering off the portable device 16. The UHF circuitry 74 may operate to provide anti-theft functionality by enabling corresponding readers to detect the UHF circuitry 74 outside of the interactive environment 14, and the corresponding readers may then trigger an alert to the control system 28 and/or other security system.

In an embodiment, the control system 28 may track achievements (e.g., record successful targeting; add points) and/or maintain the guest profile (e.g., characteristics and attributes of the virtual projectiles) on the back end as the guest travels through the interactive environment 14. In some such cases, the processor 30 may communicate the achievements and/or an updated guest profile to the processor 18 (e.g., via the UWB circuitry 58, 66) to cause the guest-specific special effects throughout the experience (e.g., to update the display screen 48 in accordance with the guest profile). Additionally or alternatively, the portable device 16 may track achievements and/or maintain aspects of the guest profile as the guest travels through the interactive environment 14. In some such cases, the processor 18 may communicate the achievements and/or an updated guest profile to the control system 28 (e.g., as part of the unique identifier; via the UWB circuitry 58, 66) to cause the guest-specific special effects throughout the experience (e.g., to provide the interactive elements 26 in accordance with the guest profile).

In an embodiment, the processor 18 (or the processor 30) may also transfer the achievements and/or a final guest profile to the one or more databases 36 at a conclusion of the experience for use in future experiences. In an embodiment, the processor 18 (or the processor 30) may transfer the achievements and/or the updated guest profile at the exit of the interactive environment 14 (e.g., as recognized by the UWB circuitry 58) where the guest may return the portable device 16 to be used by another guest. In this way, the guest profile for the guest may be maintained and updated across multiple visits to the interactive environment 14.

The memory devices 20, 32 may include one or more tangible, non-transitory, computer-readable media that store instructions executable by the processors 18, 30 and/or store data (e.g., guest profile) to be processed by the processors 18, 30. For example, the memory devices 20, 32 may include random access memory (RAM), read only memory (ROM), rewritable non-volatile memory such as flash memory, hard drives, optical discs, and/or the like. Additionally, the processors 18, 30 may include one or more general purpose microprocessors, one or more application specific processors (ASICs), one or more field programmable gate arrays (FPGAs), or any combination thereof. Further, the memory devices 20, 32 may store instructions executable by the processors 18, 30 to perform the methods and control actions described herein for the interactive system 10.

The portable devices 16 and the control system 28 may operate as a distributed and/or decentralized network of one or more controllers. The network of the one or more controllers facilitates reduction in processing time and processing power required for the one or more controllers dispersed throughout one or more interactive environments 14. The network of the one or more controllers may be configured to obtain guest profiles by requesting the guest profiles from a guest profile feed stored in the one or more databases 36. At least some of the one or more controllers may act as edge controllers that subscribe to the guest profile feed having multiple guest profiles stored in the one or more databases 36 and cache the guest profile feed to receive one or more guest profiles contained in the guest profile feed. In some embodiments, the control system 28 may itself include one or more controllers that communicate with each other through a wireless mesh network (WMN) or other wireless and/or wired communication methods. In an embodiment, this may facilitate coordination among the portable devices 16 to efficiently provide data about interactions with related interactive elements 26 (e.g., a virtual projectile crossing another virtual projectile; building upon impact of another virtual projectile), as well as improved computer operations.

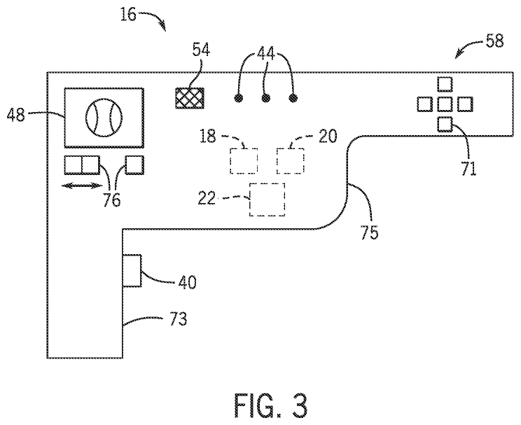

FIG. 3 is a side view of the portable device 16 with an array 71 of ultra-wideband (UWB) tags, in accordance with an embodiment of the present disclosure. To facilitate discussion, the portable device 16 is shown in a form of a targeting device, such as a blaster, with a handle 73 at a proximal end portion and that is configured to be gripped by the guest. The portable device 16 may also include a body 75 that extends from the handle 73, and the body 75 may support various components of the portable device 16, such as the UWB circuitry 58 that includes the array 71 of UWB tags. The array 71 may include any number of UWB tags (e.g., 2, 3, 4, 5, 6, 7, 8, or more) in any suitable configuration, such as a cross-shape, an X-shape, or the like. The array 71 may include the UWB tags in a two-dimensional configuration (e.g., in an x-y plane) or in a three-dimensional configuration (e.g., in an x-y-z axis system). The array 71 of the UWB tags may be positioned away from the handle 73 so that a hand of the guest does not cover the array 71 of the UWB tags as the guest holds the portable device 16 and/or the array 71 of the UWB tags may be positioned in a barrel portion of the body 75 to be proximate to a distal end portion of the portable device 16. The array 71 of the UWB tags may include multiple antennas fused into one circuit board to effectively operate as multiple UWB tags, or the array 71 of the UWB tags may include a multiplexed antenna with one UWB tag to effectively operate as the multiple UWB tags. As used herein, the UWB circuitry 58 and/or the array 71 of multiple UWB tags may include any of a variety of configurations that effectively operate as the multiple UWB tags.

As shown, the portable device 16 includes the trigger device 40 positioned along the handle 73, as well as multiple light emitters 44 and the speaker 54 to provide feedback/outputs/effects for the guest. The portable device 16 also includes the display screen 48, which is configured to display a current virtual projectile that will be launched by the portable device 16 upon actuation of the trigger device 40 (e.g., the ball will be displayed on the display screen 24 of FIG. 1 following actuation of the trigger device 40). The portable device 16 further includes the input switch(es) 76, which may enable the guest to toggle through a menu of available virtual projectiles and select one of the available virtual projectiles to be the current virtual projectile. The portable device 16 further includes various other components, such as the processor 18, the memory device 20, and one or more of the additional components 22 (e.g., the haptic device 46, the battery 52, the microphone 56, the IMU 60, the NFC circuitry 72, the UHF circuitry 74) that operate in the manner described herein. The portable device 16 may also include the targeting laser 42 and the imaging sensor 50; however, in an embodiment, the portable device 16 may be configured to operate and interact with the control system 28 (e.g., to enable determination of the location, orientation, trajectory, successful targeting, and/or communication) without the targeting laser 42 and/or without the imaging sensor 50.

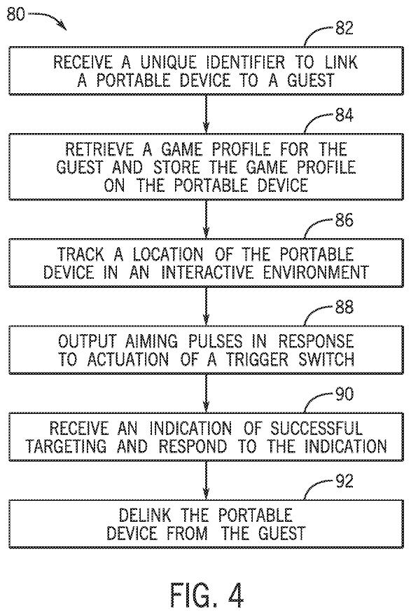

FIG. 4 illustrates a process flow diagram for a method 80 of operating the interactive system 10 to provide guest-specific special effects, wherein at least certain processing steps are carried out by the portable device 16, in accordance with an embodiment of the present disclosure. The method 80 includes various steps represented by blocks. It should be noted that at least some steps of the method 80 may be performed as an automated procedure by a system, such as the interactive system 10. Although the flow chart illustrates the steps in a certain sequence, it should be understood that the steps may be performed in any suitable order and certain steps may be carried out simultaneously, where appropriate. Additionally, steps may be added to or omitted from the method 80. Further, some of all of the steps of the method 80 may be performed by the processor 18 of the portable device 16.

In block 82, the method 80 may include receiving the unique identifier at the processor 18 of the portable device 16 to link the portable device 16 to the guest. The unique identifier may be obtained from the personal device 62 carried by the guest. The personal device 62 may be a mobile phone, a bracelet, or any other suitable device. In an embodiment, the portable device 16 may be configured to periodically scan for and/or request the unique identifier from the personal device 62. For example, the portable device 16 may use the NFC circuitry 72 to scan for the unique identifier stored on and/or accessible from the personal device 62. As another example, the portable device 16 may use DOS techniques to request sound signals that indicate the unique identifier from the personal device 62. The processor 18 may be triggered to initiate the scan and/or request upon occurrence of an event, such as by the IMU 60 detecting certain movements, the UWB circuitry 58 indicating that the portable device 16 is at the entrance of the interactive environment 14, receipt of the link command input from the guest or an operator, and/or powering on the portable device 16.

In block 84, the method 80 may include retrieving the guest profile for the guest and storing the guest profile in the memory device 20 of the portable device 16. The processor 18 of the portable device may retrieve the guest profile for the guest from the one or more databases 36, which may store multiple profiles for multiple guests. The processor 18 may download the guest profile to the memory device 20 of the portable device 16 to enable the processor 18 to adjust certain outputs and special-effects based on the guest profile. For example, the processor 18 may instruct the targeting laser 42 to send the aiming pulse encoded with characteristics or attributes of the virtual projectiles based on the guest profile, which may result in display of guest-specific characteristics or attributes of the virtual projectiles being displayed on the display screen 24 as the guest travels through the interactive environment 14.

In block 86, the method 80 may include tracking the location of the portable device 16 in the interactive environment 14. In particular, the portable device 16 may utilize the UWB circuitry 58 and/or the imaging sensor 50 to track the location and/or the orientation of the portable device 16. The UWB circuitry 58 may communicate with UWB circuitry 66 in the interactive environment 14, and the UWB circuitry 58 may provide UWB data to the processor 18 to enable the processor 18 to determine the location and/or the orientation of the portable device 16 within the interactive environment 14. The imaging sensor 50 may be configured to obtain images of the interactive environment 14 around the portable device 16, and the imaging sensor 50 may provide the images to the processor 18 to enable the processor 18 to determine the location and/or the orientation of the portable device 16 within the interactive environment 14 (e.g., via image matching to visual markers 68 in the interactive environment).

As noted herein, the UWB circuitry 58, 66 may also be utilized to exchange data between the portable device 16 and the control system 28. For example, the UWB circuitry 58, 66 may transfer the location and/or the orientation as determined by the processor 18 of the portable device to the control system 28 (along with the unique identifier and/or the guest profile) so that the control system 28 instructs display of appropriate interactive elements 26 on the display screen 24 in the interactive environment 14. The UWB circuitry 58, 66 may also facilitate communication of other information, such as the actuation of the trigger device 40, the trajectory, the characteristics or attributes for the virtual projectiles, or the like.

In block 88, the method 80 may include outputting the aiming pulses via the targeting laser 42 of the portable device 16. The aiming pulses may be detected by corresponding detectors 70 at the display screen 24, and the control system 28 may be configured to identify successful targeting of the interactive elements 26 based on the detection of the aiming pulses. In an embodiment, the aiming pulses may be emitted only in response to actuation of the trigger device 40 and/or may be encoded (e.g., via a certain frequency) to communicate occurrence of the actuation of the trigger device 40. In an embodiment, the aiming pulse may be encoded with the unique identifier for the guest so that the control system 28 may assign the achievement (e.g., the successful targeting, the points) to the guest profile for the guest on the back end. The aiming pulse may also be encoded to convey other information, such as the trajectory, the characteristics or attributes for the virtual projectiles, or the like.

In block 90, the portable device 16 may determine and/or receive an indication of successful targeting of the interactive element 26. For example, the control system 28 may provide the indication of the successful targeting of the interactive element 26 back to the portable device 16, such as via the UWB circuitry 58, 66. In any case, the portable device 16 maintains the guest profile of the guest (e.g., updated in real time or near real time during the game) and/or is prompted to respond with other actions (e.g., audio/visual effects on the portable device 16). For example, in response to the successful targeting, a celebratory audio alarm may be output by the speaker 54 of the portable device 16.

In block 92, the portable device 16 may be delinked from the guest through any of a variety of linking techniques. In an embodiment, the portable device 16 is delinked from the guest when the periodic scans by the portable device 16 do not result in the return of the unique identifier for the guest and/or result in the return of another unique identifier for another guest (or operator). It should be appreciated that the processor 18 may be triggered to delink from the guest upon occurrence of an event, such as by the IMU 60 detecting certain movements, the UWB circuitry 58 indicating that the portable device 16 is at the exit of the interactive environment 14, upon a delink command input, and/or upon powering off the portable device 16.

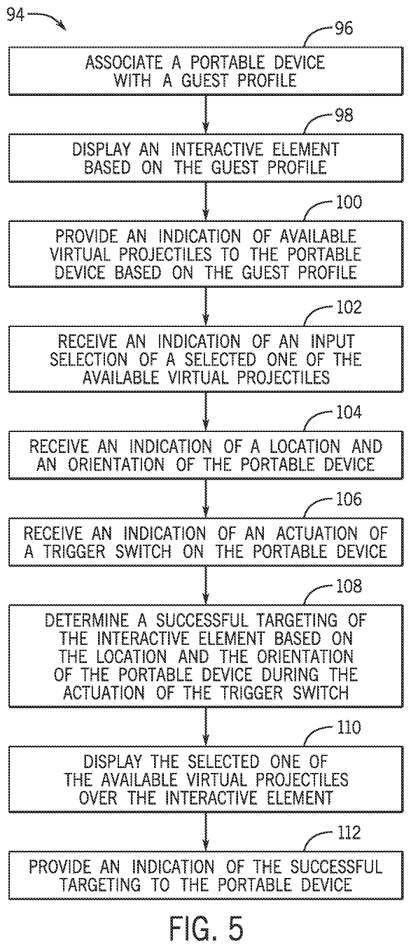

FIG. 5 illustrates a process flow diagram for a method 94 of operating the interactive system 10 to provide guest-specific special effects, wherein at least certain processing steps are carried out by the control system 28, in accordance with an embodiment of the present disclosure. The method 94 includes various steps represented by blocks. It should be noted that at least some steps of the method 94 may be performed as an automated procedure by a system, such as the interactive system 10. Although the flow chart illustrates the steps in a certain sequence, it should be understood that the steps may be performed in any suitable order and certain steps may be carried out simultaneously, where appropriate. Additionally, steps may be added to or omitted from the method 94. Further, some of all of the steps of the method 94 may be performed by the processor 30 of the control system 28.

In block 96, the method 94 may include associating the portable device 16 with the guest profile of the guest. The portable device 16 may obtain the unique identifier from the personal device 62 of the guest, and the portable device 16 may provide the unique identifier along with its own device identifier to the control system 28. Then, the control system 28 may use the unique identifier to identify the guest profile in the one or more databases 36, and then use the device identifier to associate the portable device 16 with the guest profile of the guest.

In block 98, the method 94 may include displaying the interactive element 26 on the display screen 24 in the interactive environment 14. In an embodiment, the interactive element 26 may be based on the guest profile and/or customized for the guest. For example, the guest profile may indicate a preference for a particular animated character and/or a history that shows that the guest did not experience the particular animated character during a prior visit to the interactive environment 14. Thus, the control system 28 may instruct display of the particular animated character.

In block 100, the method 94 may include providing an indication of available virtual projectiles to the portable device 16 based on the guest profile. The available virtual projectiles may include different attributes, such as types, colors, powers, effects. For example, the guest may have achieved a level that enables the guest to use gold arrows as the virtual projectiles, or the guest may have completed a task that enables the guest to use ice cubes that provide freeze effects when launched in the interactive environment 14. The control system 28 may determine the available virtual projectiles based on the guest profile.

In block 102, the method 94 may include receiving an indication of an input selection of a selected one of the available virtual projectiles. For example, the available virtual projectiles may be presented on the display screen 48 of the portable device 16, and the guest may provide the input selection via interacting (e.g., touching) the display screen 48 of the portable device 16 and/or the input switch 76 of the portable device 16. The guest may be presented with multiple different available attributes to create and to select the virtual projectile (e.g., a color gold among options gold, red, blue; a type arrow among options arrow, ball, goo) or the guest may be presented with multiple different available virtual projectiles to select the virtual projectile (e.g., a gold arrow, a red ball, blue goo). In any case, the portable device 16 may communicate the selected one of the available virtual projectiles to the control system 28.

In block 104, the method 94 may include receiving an indication of the location and the orientation of the portable device 16. The location and the orientation of the portable device 16 may be determined via communication between the UWB circuitry 58 of the portable device 16 and the UWB circuitry 66 in the interactive environment 14 (e.g., in the ceiling, walls, and/or behind the display screen 24). The control system 28 may cause the interactive element 26 to move based on the location and the orientation of the portable device 16, even before actuation of the trigger device 40 of the portable device 16 and/or even before any action to launch the virtual projectile from the portable device 16. The use of the UWB circuitry 58, 66 may enable these effects and may provide an engaging, immersive experience as the interactive element 26 may appear to duck and/or run away upon the guest aiming the portable device 16 at the interactive element 26. Notably, these effects (e.g., the response, pre-trigger movement of the interactive element 26) may be carried out with only the UWB circuitry 58, 66, or with the UWB circuitry 58, 66 and the IMU 60, but without the targeting laser 42.

In block 106, the method 94 may include receiving an indication of the actuation of the trigger device 40 of the portable device 16. The actuation of the trigger device 40 may cause communication of the indication of the actuation of the trigger device 40 via the UWB circuitry 58, 66. In block 108, the method 94 may include determining a successful targeting of the interactive element based on the location and the orientation of the portable device 16 during (e.g., at approximately a same time as) the actuation of the trigger device 40. For example, the control system 28 may determine the trajectory of the selected one of the virtual projectile based on the location and the orientation of the portable device 16, and the control system 28 may determine whether the trajectory would intersect the display screen 24 at a hit location that overlaps with the interactive element 26. In an embodiment, the control system 28 may also consider the attributes of the selected one of the available virtual projectiles to determine the successful targeting (e.g., to determine the trajectory, which pertains to the successful targeting). For example, the gold arrow may be considered to travel greater distances than the blue goo, and this may affect the successful targeting of the interactive element 26.

In block 110, the method 94 may include displaying the selected one of the available virtual projectiles over the interactive element 26 in response to the successful targeting. Additionally, in block 112, the method 94 may include providing an indication of the successful targeting to the portable device 16. The indication of the successful targeting may include an updated guest profile and/or other available virtual projectiles that are now available due to the successful targeting. The indication of the successful targeting may cause the portable device to provide feedback, such as via illuminating the light emitter(s) 44.

Advantageously, two guests within the interactive environment 14 will have different experiences, such as display of different interactive elements 26 on the display screen 24, display of the same interactive elements 26 that behave/move differently on the display screen 24 (e.g., different pre-trigger actions), display of different virtual projectiles, different audio/tactile/visual effects, and the like. When a first guest uses the portable device 16 to interact with the interactive environment 14, the control system 28 may generate different special effect instructions relative to those generated when a second guest uses the portable device 16 to interact with the interactive environment 14 at a different time (or when the second guest uses a different portable device 16 to interact with the interactive environment 14 at a same time, or when the first guest uses a different portable device 16 to interact with the interactive environment 14 at a different time).

In an embodiment, the interactive system 10 may carry out significant processing on-board the portable device 16, such as to determine the location, determine the orientation, determined the trajectory, determine the successful targeting of the interactive elements 26, and/or maintain/update the guest profile as the guest travels through the interactive environment 14. However, the portable device 16 may instead rely on communication (e.g., via the UWB circuitry 58, 66) with the control system 28, which carries out some or all of the significant processing. For example, certain ones of the additional components 22 of the portable device 16 may generate respective signals that are then transmitted, via the UWB circuitry 58, 66, to the control system 28. The processor 30 of the control system 28 processes the signals to determine the location, determine the orientation, determined the trajectory, determine the successful targeting of the interactive elements 26, and/or maintain/update the guest profile as the guest travels through the interactive environment 14. Then, the control system 28 may transmit, via the UWB circuitry 58, 66, instructions that cause the processor 18 of the portable device 16 to carry out certain steps, such as to output sounds, lights, haptics to indicate the successful targeting to the guest, to display the available virtual projectiles for selection by the guest, to cause the mode to change (e.g., enter freeze mode), and/or to provide other effects.

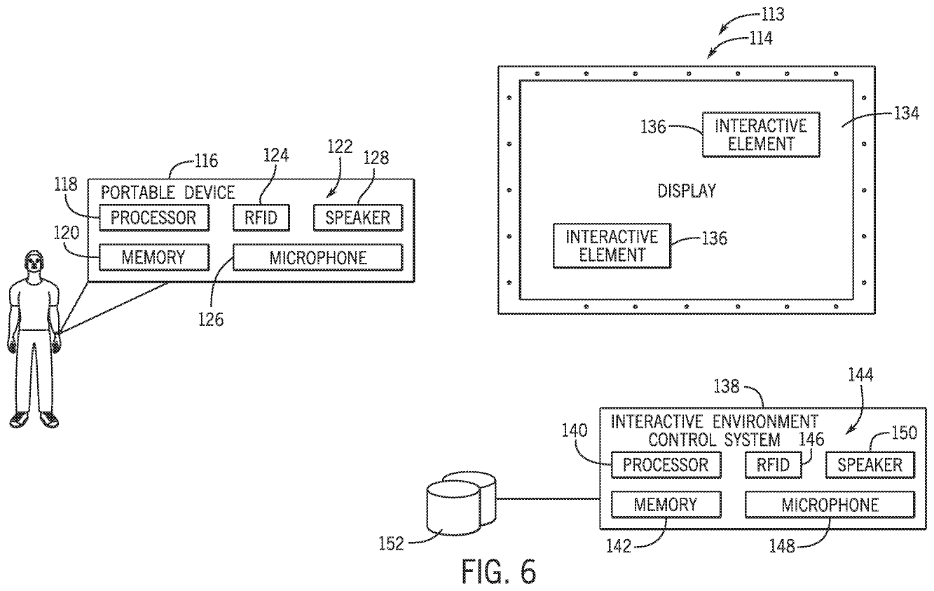

FIG. 6 illustrates an interactive system 113 that facilitates interactions within an interactive environment 114, in accordance with an embodiment of the present disclosure. The interactive environment 114 may have any of the features of the interactive environment 14 described herein with reference to FIGS. 1-5. To enjoy an immersive experience within the interactive environment 114, a guest may utilize a portable device 116. As shown, the portable device 116 is worn by the guest, such on a wrist of the guest. However, the portable device 116 may have any of a variety of forms.

The portable device 116 may be temporarily registered or linked to the guest, in the manner described herein with reference to FIGS. 1-5. Alternatively, the portable device 116 may be pre-registered or linked to the guest, such as upon purchase of the portable device 116 by the guest (or upon payment of an admission fee to access the interactive environment 14) and is not intended to be utilized by other guests. A guest profile is created for the guest and stored on the portable device 116 (e.g., only on the portable device 116), and any updates to the guest profile are determined at the portable device 116 and updated on the portable device 116 (e.g., only on the portable device 116). The portable device 116, with the guest profile stored thereon, may be utilized by the guest multiple times and over multiple visits to build upon the guest profile at each of the multiple visits.

The portable device 116 may include a processor 118, a memory device 120, and communication circuitry 122. The communication circuitry 122 may include RFID circuitry 124 (e.g., RFID tag), a microphone 126, and a speaker 128. The interactive environment 114 may include one or more display screens 134 that are configured to display interactive elements 136. An interactive environment control system 138 (e.g., control system) may include a processor 140, a memory device 142, and communication circuitry 144 to enable the control system 138 to control features within the interactive environment 114 (e.g., instruct display of the interactive elements 136 on the display screen 134 and/or other audio/visual effects) and/or communicate with the portable device 116. The communication circuitry 144 may include one or more RFID readers 146, a microphone 148, and a speaker 150. Additionally, one or more databases 152 that store guest profiles for the guests may be accessible to the portable device 116 and/or the control system 138.

The portable device 116 and the control system 138 may communicate via a combination of RF communications and DOS communications. For example, as the guest travels through the interactive environment 14, the RFID readers 146 may detect the RFID circuitry 124 in the portable device 116 and may provide an indication of the detection to the processor 140. This detection may trigger the processor 140 to instruct the speaker 150 to provide an audio signal to indicate a region of the interactive environment 14 to the portable device 116. The portable device 116 may receive the audio signal with the microphone 126, and the portable device 116 may identify the region and respond appropriately. For example, in response to being present in the region and/or gestures made with the portable device 116 in the region (e.g., as detected via an IMU and/or an imaging sensor), the portable device 116 may update the guest profile that is stored in the memory device 120 of the portable device 116 (e.g., to add points; to include that the guest completed certain gestures in the region).

In an embodiment, the portable device 116 may communicate that the guest made the gestures via DOS communications, such as by encoding the information in an audio signal that is output by the speaker 128 and that is received at the microphone 148. Then, the control system 138 may instruct the display screen 134 to present different interactive elements 136 and/or initiate other audio/visual effects within the interactive environment 114 based on the audio signal. Thus, after an initial recognition via RFID communication, the DOS communication may be the primary technique for conveying information between the portable device 116 and the control system 138. It should be appreciated that the features disclosed with reference to FIGS. 1-5 and the features disclosed with reference to FIG. 6 may be combined in any suitable manner to provide an immersive experience to guests.

Advantageously, the interactive systems may provide data collection and/or computation at peripherals (e.g., edge compute) for more efficient processing and reduced latency. The various components, such as the UWB circuitry and/or the IMU, within the portable devices carried by guests through the interactive environments may also enable fusion of sensor data so that targeting can be assessed accurately and/or on the portable devices, for example. The interactive systems may also facilitate coordination of effects, such as combined (e.g., stacked, sequential) virtual impacts from multiple virtual projectiles (e.g., when two virtual projectiles hit within a limited timeframe, a unique result, such as a bigger explosion, occurs).

While only certain features have been illustrated and described herein, many modifications and changes will occur to those skilled in the art. It is, therefore, to be understood that the appended claims are intended to cover all such modifications and changes as fall within the true spirit of the disclosure.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform] ing [a function] . . . ” or “step for [perform] ing [a function] . . . ” it is intended that such elements are to be interpreted under 35 U.S.C. 112(f). However, for any claims containing elements designated in any other manner, it is intended that such elements are not to be interpreted under 35 U.S.C. 112(f).

1. An interactive system, comprising:
a portable device configured to be carried by a user as the user travels through an interactive attraction, wherein the portable device comprises a trigger device and first ultra-wideband (UWB) circuitry;
a control system comprising second UWB circuitry and one or more processors, wherein the one or more processors are configured to:
determine a location and an orientation of the portable device within the interactive attraction based on communication between the first UWB circuitry and the second UWB circuitry;
receive an indication of actuation of the trigger device via communication between the first UWB circuitry and the second UWB circuitry; and
display a virtual projectile on a display screen of the interactive attraction based on the location and the orientation of the portable device during the actuation of the trigger device.

2. The interactive system of claim 1, wherein the one or more processors are configured to:
receive a unique identifier associated with the user and a device identifier associated with the portable device;
access a user profile for the user from one or more databases based on the unique identifier; and
link the user profile to the portable device based on the device identifier.

3. The interactive system of claim 2, wherein the portable device comprises near-field communication (NFC) circuitry and is configured to receive the unique identifier associated with the user via communication between the NFC circuitry and a personal device of the user.

4. The interactive system of claim 1, wherein the one or more processors are configured to:
determine a plurality of available virtual projectiles based on a user profile for the user; and
provide an additional indication of the plurality of available virtual projectiles to the portable device via communication between the first UWB circuitry and the second UWB circuitry.

5. The interactive system of claim 4, wherein the plurality of available virtual projectiles vary by a size, a color, a type, or any combination thereof.

6. The interactive system of claim 4, wherein the portable device comprises an object display screen that is configured to display the plurality of available virtual projectiles for visualization by the user.

7. The interactive system of claim 6, wherein the portable device enables an input by the user to select the virtual projectile from the plurality of available virtual projectiles, and the one or more processors are configured to receive another indication of the input to select the virtual projectile via communication between the first UWB circuitry and the second UWB circuitry.

8. The interactive system of claim 1, wherein the first UWB circuitry comprises an array of multiple UWB tags.

9. The interactive system of claim 1, wherein the one or more processors are configured to:
display an interactive element on the display screen; and
determine a successful targeting of the interactive element based on the location and the orientation of the portable device during the actuation of the trigger device; and
in response to the successful targeting, display the virtual projectile to overlap with the interactive element on the display screen of the interactive attraction.

10. The interactive system of claim 9, wherein the one or more processors are configured to:
determine an additional virtual projectile is available to the user due to the successful targeting, wherein the virtual projectile and the additional virtual projectile vary by at least one attribute; and
in response to subsequently receiving an additional indication of an additional actuation of the trigger device via communication between the first UWB circuitry and the second UWB circuitry, display the additional virtual projectile on the display screen of the interactive attraction based on a respective location and a respective orientation of the portable device during the additional actuation of the trigger device.

11. The interactive system of claim 1, wherein the one or more processors are configured to display an interactive element on the display screen and to represent movement of the interactive element on the display screen in response to the location and the orientation of the portable device indicating that the portable device is aimed at the interactive element prior to the actuation of the trigger device.

12. The interactive system of claim 1, wherein the portable device comprises a data-over-sound system comprising a microphone and a speaker, and the one or more processors are configured output a sound signal to communicate data to the data-over-sound system of the portable device.

13. A method of operating an interactive system, the method comprising:
determining, using one or more processors, a location and an orientation of a portable device within an interactive attraction based on communication between first UWB circuitry of the portable device and second UWB circuitry positioned about the interactive attraction;
receiving, at the one or more processors, an indication of actuation of a trigger device of the portable device via the communication between the first UWB circuitry and the second UWB circuitry; and
displaying, via the one or more processors, a virtual projectile on a display screen of the interactive attraction based on the location and the orientation of the portable device during the actuation of the trigger device.

14. The method of claim 13, comprising:
determining, via the one or more processors, a successful targeting of an interactive element displayed on the display screen of the interactive attraction; and
updating, via the one or more processors, a user profile for a user to reflect the successful targeting.

15. The method of claim 14, comprising:
providing, via communication between the first UWB circuitry and the second UWB circuitry, feedback of the successful targeting to the portable device; and
instructing, via one or more respective processors of the portable device, an output via an output device of the portable device in response to the feedback of the successful targeting.

16. The method of claim 13, comprising:
displaying, via the one or more processors, an interactive element on the display screen; and
displaying, via the one or more processors, movement of the interactive element on the display screen in response to the location and the orientation of the portable device indicating that the portable device is aimed at the interactive element prior to the actuation of the trigger device.

17. An interactive system, comprising:
a portable device, comprising:
a memory device configured to store a user profile for a user of the portable device;
a processor configured to determine an attribute of a virtual projectile for the portable device based on the user profile; and
communication circuitry configured to communicate the attribute of the virtual projectile to a control system to cause the control system to display the virtual projectile with the attribute on a display screen that is separate from the portable device.

18. The interactive system of claim 17, wherein the attribute of the virtual projectile comprises a size, a color, a type, or any combination thereof.

19. The interactive system of claim 17, wherein the communication circuitry comprises ultra-wideband circuitry.

20. The interactive system of claim 19, wherein the ultra-wideband circuitry is configured to detect a location of the portable device relative to the display screen and to communicate the location to the control system.
